(19) United States
(12) Patent Application Publication
(10) Pub. No.: US 2015/0361626 A1
(43) Pub. Date: Dec. 17, 2015

(54) METHOD FOR HEATING A PAVER SCREED OF A ROAD PAVER

(71) Applicant: AMMANN SCHWEIZ AG, Langenthal (CH)

(72) Inventors: Uwe Trox, Langenthal (CH); Giuseppe Romano, Langenthal (CH)

(73) Assignee: AMMANN SCHWEIZ AG, Langenthal (CH)

(21) Appl. No.: 14/764,444

(22) PCT Filed: Feb. 14, 2013
(86) PCT No.: PCT/CH2013/000031

§ 371 Date: Jul. 29, 2015

(51) Int. Cl. E01C 19/48; H05B 3/00

(52) U.S. Cl. CPC E01C 19/48; H05B 3/0014; E01C 2301/10

(57) ABSTRACT

The invention concerns a method for heating a paver screed (10) of a road paver equipped with a heating device, wherein the heating device comprises electrical heating elements (2), which for generating heat are charged with electric current by a current generator (1). For changing the heating power of the heating device, the voltage (U), the heating elements (2) are charged with, is changed. Thus, for controlling or regulating, respectively, the heating power the voltage charged to the individual heating element (2) is increased or reduced. By this, an energy-efficient operation is made possible and the service life of the heating elements (2) as well as of the generator (1) can significantly be increased. Likewise, the motor driving the generator (1) is spared and in case of a combustion engine, e.g. a diesel engine, also fuel is saved.

This application claims the priority of PCT Application No. PCT/CH2013/000031, filed on Feb. 14, 2013, the disclosure of which is incorporated herein by reference in its entirety.

### TECHNICAL FIELD

The invention relates to a method for heating a paver screed of a road paver equipped with an electric heating device as well as to a road paver, in particular for performing said method, according to the preambles of the independent claims.

### BACKGROUND ART

It is common in road pavers to heat the working components of the paver screed either electrically or with gas heating. This applies in particular for the so called tamper bars, the soil plates and for the pressure bars, if such are provided. These working components have to be heated up until the material to be paved, which is hot as well, does not anymore tend to sticking. The temperature of the material, which is build in by the paver screed, is e.g. about 170° C. The heating needs to be continued during the building in of the material.

In an electrical paver screed heating device for example electrical heating rods are distributed within the paver screed, which by a three-phase generator driven by a primary drive unit, in most cases a diesel engine, are charged with three-phase alternating current. It is common to operate the paver screed heating device permanently and with full power. By this, however, the three-phase generator, in particular in unfavorable operating conditions, is permanently highly loaded and energy is wasted.

From EP 1 036 883 A2 a method for heating the paver screed of a road paver is known, in which after the heating-up phase in the actual paving operation the individual heating elements of the heating device are in a clocked manner switched on and off. By this the average loading of the generator can be reduced and the production of heat of the heating device can be adapted to the actual requirements. This method, however, has the disadvantage that a multitude of switching arrangements is required and the service life of the heating elements is significantly reduced due to the enduring switching on and off. This in turn leads to increased investment and maintenance costs. Furthermore, in a simple intermittent switching on and off operation of individual heating elements, it comes to an abrupt intermittent loading of the generator, which is detrimental to its service life. Also the primary drive motor is operated or loaded, respectively, intermittently, which as well is detrimental to its service life and in case of a combustion engine, e.g. a diesel engine, leads to an increased fuel consumption.

### SUMMARY OF THE INVENTION

Hence, it is a general object of the invention to provide methods and devices which do not have the before described disadvantages of the prior art or avoid them at least partially.

This object is achieved by the subjects of the independent claims.

Accordingly, a first aspect of the invention concerns a method for heating a paver screed of a road paver equipped with a heating device, which comprises one or several electrical heating elements. These are preferably resistance heating elements. However, also other electrical heating elements are intended to be used, like e.g. quartz radiators. Also it is possible to use other heating devices in addition to the electrical heating elements, e.g. gas burners.

The one or the several electrical heating elements by means of a current generator are charged with electrical current, so that they as intended produce heat, for heating the paver screed. According to the invention, the heating power of the one or several heating elements of the heating device is changed by changing the voltage this or these heating elements are charged with.

Thus, for controlling or regulating, respectively, the heating power, no switching on and off of the one or several heating elements takes place, as is known from the prior art, but an increase or decrease of the voltage charged to the respective heating element. By this, an energy-efficient operation is made possible and the service life of the heating elements as well as of the generator can significantly be increased. Likewise the primary drive motor is spared and in case of a combustion engine, e.g. a diesel engine, fuel is saved.

In a preferred embodiment of the method, the voltage that the one or the several heating elements are charged with, and associated with the heating power of the heating device, is changed by changing the voltage generated by the current generator.

This by advantage is accomplished in that the exciting current of the current generator is changed and/or in that the driving speed of the current generator is changed. How this can be done is well known to the person skilled in the art and does not need to be explained here more into detail.

In particular in case that the voltage is changed solely in this way, the advantage is arrived at that expensive switching and/or regulating equipment between the current generator and the one or several heating elements can be dispensed with. Also, a stepless change of the voltage and thus of the power taken by the heating elements becomes possible by this with simple means, so that abrupt changes in load at the current generator can be avoided and a precise temperature control can be achieved.

In case a heating device comprising several electrical heating element is used in the method according to the invention, which case is preferred, it is of advantage to use a three-phase current generator as current generator for charging the heating elements with electric current. Such generators are powerful, robust and are available as standard components at competitive prices.

In this case in a preferred variant of the method, the voltage, at least some of the heating elements are charged with, is changed in that these heating elements are connected to the three-phase current generator temporarily in star connection and temporarily in delta connection. Preferably, the electrical heating elements of the heating device can be configured in such a manner that with them a symmetrical loading of the three-phase current generator is possible.

In delta connection, the heating elements in each case are charged with the voltage that is present between the respective phases of the three-phase current generator which are connected by them. In star connection, the heating elements are charged in each case with a substantially lower voltage. By this, with simple means two different power levels can be realized in accordance with the invention.

If in doing so a heating device is used which comprises at least two groups of electrical heating elements, which in star connection as well as in delta connection can be operated, what is preferred, then according to a preferred variant of the method the voltage, these heating elements are charged with, is changed in that these groups temporarily simultaneously in star connection and/or temporarily simultaneously in delta connection are connected to the current generator, and temporarily in an alternating clocked manner in star and delta connection are connected to the current generator. By this, with simple means up to three different power levels of the heating device can be realized in accordance with the invention.

In still a further preferred embodiment of the method, the voltage, the one or several electrical heating elements of the heating device are charged with, is changed in dependency of one or several operating parameters of the road paver, of the paver screed and/or of the current generator. Such parameters can for example be the temperatures of components, in particular of the working components, of tamper bars, soil plates and/or pressure bars of the paver screed, the temperature of the asphalt to be build in at a specific location inside the road paver, in particular directly in front of the paver screed, the moving speed of the road paver and/or the winding temperatures of the current generator. By this it becomes possible to optimally adapt the heating of the paver screed to the respective requirements and conditions.

According to a preferred variant of the method it is intended to reduce the voltage, the one or several electrical heating elements charged with, upon exceeding of a temperature at the current generator, e.g. of a temperature measured at the winding of the current generator, and/or upon exceeding of a temperature at the paver screed or in the vicinity of the paver screed, e.g. a temperature of working components of the paver screed. By this the current generator can be protected against overloading and/or an unnecessary high heating up of the paver screed, which would come along with an unnecessary energy consumption, can be avoided.

According to a further preferred variant of the method it is intended to increase the voltage, the one or several electrical heating element are charged with, upon undershooting of a temperature at the current generator, e.g. a temperature measured at the winding of the current generator, and/or upon undershooting of a temperature at the paver screed or in the vicinity of the paver screed, e.g. a temperature of working components of the paver screed. By this, within the loading capacity of the current generator the heating power can optimally be adapted to the respective requirements.

In still a further preferred embodiment of the method, the voltage, the one or several electrical heating element are charged with, temporarily is adjusted such that the current generator is operated at overload. By this, momentarily a huge heating power can be provided, which in particular is of advantage for the heating-up of the paver screed before the intended paving operation, since by this the heating-up time can be reduced.

Correspondingly, according to a preferred variant of the method, for the initial heating-up of the paver screed, the voltage, the one or several electrical heating element are charged with, is adjusted such that the current generator is operated at overload, preferably at maximum overload. Upon exceeding of a particular temperature measured at the current generator, by advantage of a particular winding temperature of the current generator, and/or upon exceeding of a particular temperature measured at the paver screed, preferably a particular temperature of working components of the paver screed, the voltage is reduced to a voltage at which the current generator is operated at nominal load or partial load.

According to a further variant of the method, it also might be preferred to temporarily increase the voltage, the one or several electrical heating elements are charged with, starting from a voltage at which the current generator is operated at nominal load or at partial load, in dependency of one or several operating parameters of the road paver, of the paver screed and/or of the current generator to a voltage at which the current generator is operated at overload. Such an operation is in particular meaningful in cases when a long partial load operation period is followed by a short term period having a substantially higher heating power demand, e.g. when after break, in which the paver screed is kept on a temperature lower than the operating temperature for saving energy, it shall be heated-up again to operation temperature as quick as possible.

A second aspect of the invention concerns a road paver, which preferably is suitable for performing the method according to the first aspect of the invention. The road paver comprises a paver screed, which is equipped with an electrical heating device comprising one or several electrical heating elements. The one or several heating elements preferably are embodied as resistance heating elements. Furthermore, the road paver comprises a current generator for charging the one or several heating elements with electric current in order to produce heat. According to the invention, the road paver comprises equipment by means of which the voltage, the one or several electrical heating elements in the intended operation are charged with, purposefully can be changed for changing the heating power of the heating device.

In the road pavers according to the invention the heating power of the paver screed can be controlled or regulated, respectively, without switching on and off of the one or several heating elements, so that an energy-efficient operation is made possible and the service life of the heating elements as well as of the generator can significantly be increased. Likewise, the primary drive motor is constantly loaded, so that it is spared and in case of a combustion engine, e.g. a diesel engine, fuel is saved.

In a preferred embodiment of the road paver, the equipment for changing the voltage, the one or several electrical heating elements are chargeable with, is designed in such a way that with it a changing of the voltage generated by the current generator can be effected.

For this purpose this equipment by advantage is designed in such a way that by it the exciting current of the current generator and/or the driving speed of the current generator can be changed, which in turn results in a change of the voltage generated by the current generator.

In particular in case that the voltage is changed exclusively by changing the exciting current and/or the driving speed of the generator, the advantage is arrived at that expensive switching and/or regulating equipment between the current generator and the heating elements can be dispensed with and also a stepless change of the voltage becomes possible. By the last mentioned measure, abrupt changes in load at the current generator can be avoided, which is beneficial for the service life of the generator and the motor driving it, preferably a diesel engine.

In a further preferred embodiment, the generator of the road paver is a three-phase current generator. Furthermore, the heating device comprises several electrical heating elements, by means of which the three phases of the three-phase current generator in the intended operation preferably symmetrically can be loaded. Such generators are quite powerful, robust and well-priced and furthermore make possible an operation of several electrical heating elements optionally in star connection and in delta connection.

Correspondingly, the equipment for changing the voltage, the at least one electrical heating element is charged with, according to a preferred variant of the method is designed in such a way that with it the heating elements of the heating device can be connected to the three-phase current generator in star connection as well as in delta connection. In delta connection the heating elements in each case are charged with the voltage that is present between the respective phases of the three-phase current generator which are connected by them. In star connection the heating elements are charged in each case with a substantially lower voltage. By this, with simple means two different power levels of the heating device can be realized.

By advantage, the heating device comprises at least two groups of electrical heating elements, which independently of each other in star connection as well as in delta connection can be operated with the three-phase current generator. The equipment for changing the voltage, these two groups of electrical heating elements are charged with, in this variant is designed in such a way that by it these groups of heating elements can be simultaneously in star connection and/or simultaneously in delta connection as well as in an alternating manner in star and delta connection can be connected to the current generator. By this, with little investment on the equipment side, up to three different power levels of the heating device can be realized.

In still another preferred embodiment of the road paver, the equipment for changing the voltage comprises a control unit, by means of which this voltage can be changed in dependency of one or several operating parameters of the road paver, of the paver screed and/or of the current generator, preferably in an automated manner.

The control unit by advantage comprises equipment for determining specific temperatures at the current generator, preferably for determining of a winding temperature of the current generator, and/or comprises equipment for determining specific temperatures at the paver screed or in the vicinity of the paver screed, preferably for determining the temperature of working components of the paver screed, and is designed in such a way that with it the voltage, the one or several electrical heating elements are charged with, in dependency of the determined temperatures can be changed.

By this it becomes possible to optimally adapt the heating of the paver screed to the respective requirements and conditions.

In a preferred variant, the control unit is designed in such a way that it can reduce the voltage, the one or several electrical heating elements are charged with, upon exceeding of a temperature at the current generator, e.g. a temperature measured at the winding of the current generator, and/or upon exceeding of a temperature at the paver screed or in the vicinity of the paver screed, e.g. a temperature of working components of the paver screed, namely preferably to a predetermined value. By this, the current generator can be protected against overload and/or an unnecessary heating-up of the paver screed, which would lead to an unnecessary consumption of energy, can be avoided.

In a further preferred variant, the control unit is designed in such a way that it can increase the voltage, the one or several electrical heating elements are charged with, upon undershooting of a temperature at the current generator, e.g. a winding temperature of the current generator, and/or upon undershooting of a temperature at the paver screed or in the vicinity of the paver screed, e.g. a particular temperature of working components of the paver screed, preferably to a predetermined value. By this, within the loading capacity of the generator, the heating power can optimally be adapted to the respective requirements.

In still a further preferred variant, the control unit is designed in such a way that it can temporarily adjust the voltage, the one or several electrical heating elements are charged with, such that the current generator is operated at overload.

In this variant it is further preferred that the control unit comprises an operation mode in which for the initial heating-up of the paver screed the voltage, the one or several electrical heating elements are charged with, is adjusted such that the current generator is operated at overload, preferably at maximum overload, and upon exceeding of a temperature at the current generator, preferably of a particular winding temperature of the current generator, and/or upon exceeding of a temperature at the paver screed, preferably of a particular temperature of working components of the paver screed, the voltage, the one or several electrical heating elements are charged with, is reduced to a voltage at which the current generator is operated at nominal load or partial load.

By this temporarily a huge heating power can be provided, which is of advantage in particular during the initial heating-up of the paver screed, since by doing so the heating-up time can be reduced.

In still a further preferred variant, the control unit is designed in such a way that it can temporarily increase the voltage, the one or several electrical heating elements are charged with, starting from a voltage at which the current generator is operated at nominal load or partial load, in dependency of one or several operating parameters of the road paver, of the paver screed and/or of the current generator, to a voltage at which the current generator is operated at overload. By this, it becomes possible to provide on short term base a substantially higher heating power than the nominal heating power, e.g. when after a break, in which the paver screed is kept on a temperature lower than the operating temperature for saving energy, it shall be heated-up again to operation temperature as quick as possible.

### BRIEF DESCRIPTION OF THE DRAWINGS

Further embodiments, advantages and applications of the invention will become apparent from the depending claims and from the following description of the drawings. Therein show:

FIG. 1 schematically the heating device of the paver screed of a first road paver according to the invention; and

FIG. 2 schematically the heating device of the paver screed of a second road paver according to the invention.

### DESCRIPTION OF THE PREFERRED EMBODIMENTS

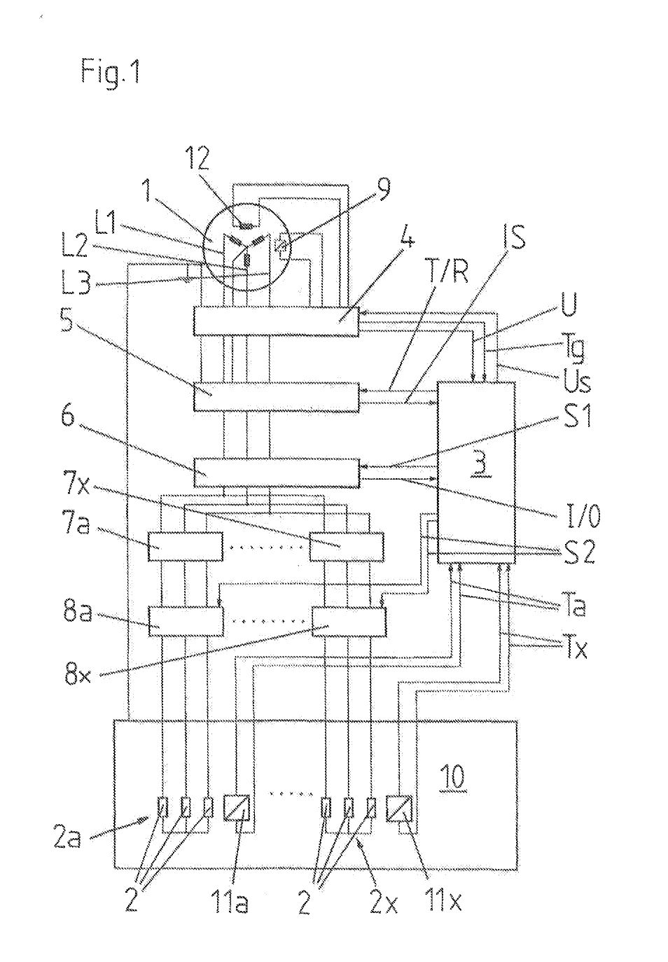

FIG. 1 shows the scheme of a heating device of the paver screed of a first road paver according to the invention with a dedicated control unit for performing the method according to the invention.

As can be seen, this heating device comprises as main components a three-phase current generator 1, several heating element groups 2a-2x each comprising three identical electrical resistance heating elements 2, which are arranged in the paver screed 10 of the road paver, as well as a computer based control unit 3 for regulating or adjusting, respectively, the heating power of the heating elements 2.

The groups 2a-2x of heating elements 2 via a common voltage regulator 4, a common device for detecting short-circuit to ground 5 (insulation measurement device, fault current detection), a common main contactor 6 (galvanic isolation) as well as per group 2a-2x via fuses 7a-7x individually dedicated to each group (line safety) and power switches 8a-8x (electronically or electromechanically) are connected or are connectable in star connection to the three phases L1, L2, L3 of the three-phase current generator 1.

The generator 1, the voltage regulator 4, the device for detecting short-circuit to ground 5 as well as the paver screed 10 are galvanically connected with each other for an electrical potential equalization.

The generator 1 is equipped with a temperature sensor 9, which provides the control unit 3 via the voltage regulator 4 with the actual value of the generator temperature Tg. Additionally, the control unit 3 receives from the voltage regulator 4 an actual value of the generator voltage U.

The paver screed 10 comprises for each of the heating element groups 2a2x a temperature sensor 11a-11x dedicated to the respective group, which senses a paver screed temperature in the area of the heating element group 2a-2x it is dedicated to and which is connected with the control unit 3 for transmitting to it the respective actual temperature value Ta-Tx.

The device for detecting short-circuit to ground 5 provides the control unit 3 with the actual value of the insulation IS and can be controlled by the control unit 3 for testing and/or reset purposes T/R.

The main contactor 6 reports its actual switching status I/O to the control unit 3 and receives its switching commands S1 from the control unit 3.

The power switches 8a-8x receive their switching commands S2 likewise from the control unit 3.

The adjustment or regulation, respectively, of the heating power of the heating element groups 2a-2x takes place via the control unit 3. It notifies to the voltage regulator 4 a desired value of the generator voltage Us, which corresponds to a desired heating power, and the voltage regulator thereupon changes the exciter current for the exciter winding 12 until the actual value of the generator voltage U corresponds to the desired value of the generator voltage Us.

In case the desired heating power or the generator voltage required for it, respectively, undershoots the voltage range of the generator which can be controlled by a change of the exciter current, for further decrease of the heating power the heating element groups 2a-2x through the control unit 3 by means of the respective power switch 8a-8x via S2 can in intervals be switched on and off, preferably in an alternating clocked manner.

The desired heating power or the desired value of generator voltage Us, respectively, can be determined by the control unit 3 in different ways.

Generally, there is the possibility to tell to the control unit 3 a desired paver screed temperature, whereupon the control unit continuously compares the paver screed temperatures Ta-Tx sensed by the temperature sensors 11a-11x with the desired paver screed temperature and according to a suitable algorithm determines the actual required heating power and the corresponding desired value of the generator voltage Us and adjusts it via the voltage regulator 4.

Also there is the possibility to operate the control unit 3 program-controlled, for automatically achieve a desired temperature course at the paver screed.

Thus, in the present case the control unit 3 e.g. comprises a “cold start operation mode”, in which, for an initial fast heating-up of the paver screed 10, it increases the generator voltage U by providing a corresponding desired value of the generator voltage Us in such a manner that in the beginning the current generator 1, as long as its windings are still cold, is operated at maximum permissible overload and upon reaching a specific measured generator temperature Tg automatically decreases it to a generator voltage U at which the generator 1 is operated at nominal load or partial load.

Generally, in the present heating device the temperature sensor 9 serves as overload protection for the generator 1. In case the measured generator temperature Tg exceeds a specific threshold value, the control unit 3 automatically reduces the requested generator voltage, for relieving the generator 1.

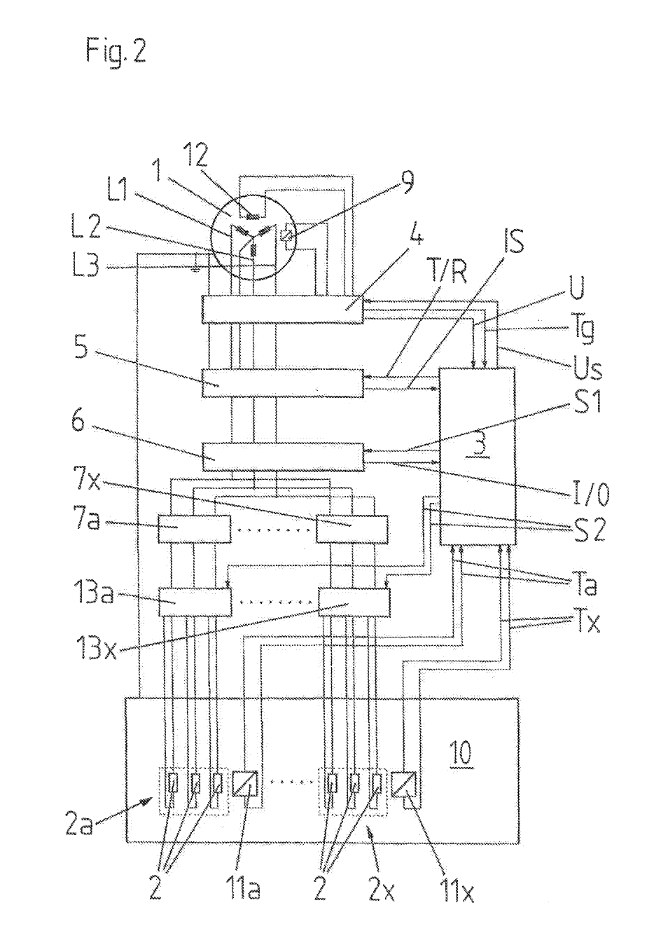

FIG. 2 shows the scheme of a heating device of the paver screed of a second road paver according to the invention with a dedicated control unit for performing the method according to the invention.

This heating device differs from the one shown in FIG. 1 merely in that instead of the simple power switches for each of the heating element groups 2a2x it comprises a switching unit 13a-13x, by which the respective group 2a-2x by means of a switching command S from the control unit 3 can optionally be connected in star connection or in delta connection with the three phases of the three-phase current generator 1 or also can be disconnected from the generator 1.

In case the desired heating power or the generator voltage required for it, respectively, undershoots the voltage range of the generator which can be controlled by changing the exciter current, for a further decrease of the heating power the heating element groups 2a-2x from the control unit 3 by means of the power switches 8a-8x cannot only in intervals by switched on and off, as is the case in the heating device according to FIG. 1, but e.g. can also be alternately be operated in star connection and in delta connection, which takes place preferably in an alternating clocked manner, or also exclusively in star connection, depending on how much heating power shall be provided.

While in the present application there are described preferred embodiments of the invention, it is to be distinctly understood that the invention is not limited thereto but might be otherwise variously embodied and practiced within the scope of the following claims.

1-27. (canceled)

28. Method for heating a paver screed (10) of a road paver equipped with a heating device,
wherein the heating device comprises several electrical heating elements (2), in particular resistance heating elements (2), which by means of a current generator (1) are charged with electrical current, wherein for changing the heating power of the heating device, the voltage, the heating elements (2) are charged with, is changed,
wherein as current generator (1) a three-phase current generator (1) is used,
characterized in that the voltage (U), the heating elements (2) are charged with, is changed in that these heating elements (2) are connected to the three-phase current generator (1) temporarily in star connection and temporarily in delta connection,
and that the heating device comprises at least two groups (2a-2x) of electrical heating elements (2), which in star connection as well as in delta connection can be operated, and that the voltage (U), these heating elements (2) are charged with, is changed in that these groups (2a-2x) temporarily simultaneously in star connection and/or temporarily simultaneously in delta connection are connected to the current generator (1), and temporarily in an alternating clocked manner in star and delta connection are connected to the current generator (1).

29. Method according to claim 28, characterized in that, for changing the heating power of the heating device, the voltage (U) generated by the current generator (1) is changed.

30. Method according to claim 29, characterized in that, for changing the voltage (U), the exciting current of the current generator (1) is changed.

31. Method according to claim 29, characterized in that, for changing the voltage (U), the driving speed of the current generator (1) is changed.

32. Method according to claim 28, characterized in that the voltage (U), the electrical heating elements (2) are charged with, is changed in dependency of one or several operating parameters (Ta-Tx, Ts) of the road paver, of the paver screed (10) and/or of the current generator (1).

33. Method according to claim 32, characterized in that the voltage (U), the electrical heating elements (2) are charged with, is reduced upon exceeding of a particular temperature (Ts) measured at the current generator (1), in particular of a particular winding temperature of the current generator (1), and/or upon exceeding of a particular temperature (Ta-Tx) measured at the paver screed (10) or in the vicinity of the paver screed (10), in particular of a particular temperature (Ta-Tx) of working components of the paver screed (10).

34. Method according to claim 32, characterized in that the voltage (10), the electrical heating elements (2) are charged with, is increased upon undershooting of a particular temperature (Ts) measured at the current generator (1), in particular of a particular winding temperature of the current generator (1), and/or upon undershooting of a particular temperature (Ta-Tx) measured at the paver screed (10) or in the vicinity of the paver screed (10), in particular of a particular temperature (Ta-Tx) of working components of the paver screed (10).

35. Method according to claim 28, characterized in that the voltage (U), the electrical heating elements (2) are charged with, temporarily is adjusted such that the current generator (1) is operated at overload.

36. Method according to claim 35, characterized in that, for the initial heating-up of the paver screed (10), the voltage (U), the electrical heating elements (2) are charged with, is adjusted such that the current generator (1) is operated at overload, in particular at maximum overload, and upon exceeding of a particular temperature (Ts) measured at the current generator (1), in particular of a particular winding temperature of the current generator (1), and/or upon exceeding of a particular temperature (Ta-Tx) measured at the paver screed (10), in particular of a particular temperature (Ta-Tx) of working components of the paver screed (10), the voltage (U), the electrical heating elements (2) are charged with, is reduced to a voltage (U) at which the current generator (1) is operated at nominal load or partial load.

37. Method according to claim 35, characterized in that the voltage (U), the electrical heating elements (2) are charged with, starting from a voltage (U) at which the current generator (1) is operated at nominal load or partial load, in dependency of one or several operating parameters (Ta-Tx, Ts) of the road paver, of the paver screed (10) and/or of the current generator (1), is temporarily increased to a voltage (U) at which the current generator (1) is operated at overload.

38. Road paver, having a paver screed (10), which is equipped with a heating device comprising several electrical heating elements (2), in particular resistance heating elements (2), and having a current generator (1) for charging the heating elements (2) with electric current, wherein the road paver comprises equipment (3, 4) by means of which the voltage (U), the heating elements (2) are charged with, purposefully can be changed for changing the heating power of the heating device,
wherein the current generator (1) is a three-phase current generator (1) and the heating device comprises several electrical heating elements (2), by means of which the three phases of the three-phase current generator (1) in the intended operation in particular symmetrically can be loaded,
characterized in that the equipment (3, 4) for changing the voltage (U), the electrical heating elements (2) are charged with, is designed in such a way that by means of it these heating elements (2) of the heating device can be connected to the current generator (1) in star connection as well as in delta connection,
and that the heating device comprises at least two groups (2a-2x) of electrical heating elements (2), which in star connection as well as in delta connection can be operated, and that the equipment (3, 4) for changing the voltage (U), these groups (2a-2x) of electrical heating elements (2) are charged with, is designed in such a way that by it these groups (2a-2x) of heating elements (2) simultaneously in star connection and/or simultaneously in delta connection can be connected to the current generator (1) as well as in an alternating clocked manner in star and delta connection can be connected to the current generator (1).

39. Road paver according to claim 38, characterized in that the road paver is designed in such a way that in the intended operation a change of the heating power of the heating device can be effected by changing the voltage (U) generated by the current generator (1).

40. Road paver according to claim 39, characterized in that the equipment (3, 4) for changing the voltage (U), the heating elements (2) are charged with, is designed in such a way that the exciting current of the current generator (1) and the driving speed of the current generator (1) can be changed with it, for changing the voltage (U) generated by the current generator (1).

41. Road paver according to claim 38, characterized in that the equipment (3, 4) for changing the voltage (U), the electrical heating elements (2) are charged with, comprises a control unit (3, 4) by means of which this voltage (U) can be changed, in particular in an automated manner, in dependency of one or several operating parameters (Ta-Tx, Ts) of the road paver, of the paver screed (10) and/or of the current generator (1).

42. Road paver according to claim 41, characterized in that the control unit (3, 4) comprises equipment (9) for determining specific temperatures (Ts) at the current generator (1), in particular for determining the winding temperature of the current generator (1), and/or comprises equipment (11a-11x) for determining specific temperatures (Ta-Tx) at the paver screed (10) or in the vicinity of the paver screed (10), in particular for determining the temperature (Ta-Tx) of working components of the paver screed (10), and is designed in such a way that with it the voltage (U), the electrical heating elements (2) are charged with, in dependency of the determined temperatures (Ta-Tx, Ts) can be changed.

43. Road paver according to claim 42, characterized in that the control unit (3, 4) is designed in such a way that the voltage (U), the electrical heating elements (2) are charged with, can be reduced, in particular to a predetermined value, upon exceeding of a particular temperature (Ts) measured at the current generator (1), in particular of a particular winding temperature of the current generator (1), and/or upon exceeding of a particular temperature (Ta-Tx) measured at the paver screed (10) or in the vicinity of the paver screed (10), in particular of a particular temperature (Ta-Tx) of working components of the paver screed (10).

44. Road paver according to claim 42, characterized in that the control unit (3, 4) is designed in such a way that the voltage (U), the electrical heating elements (2) are charged with, can be increased, in particular to a predetermined value, upon undershooting of a particular temperature (Ts) measured at the current generator (1), in particular of a particular winding temperature of the current generator (1), and upon undershooting of a particular temperature (Ta-Tx) measured at the paver screed (10) or in the vicinity of the paver screed (10), in particular of a particular temperature (Ta-Tx) of working components of the paver screed (10).

45. Road paver according to claim 41, characterized in that the control unit (3, 4) is designed in such a way that temporarily it can adjust the voltage (U), the electrical heating elements (2) are charged with, such that the current generator (1) is operated under overload.

46. Road paver according to claim 45, characterized in that the control unit (3, 4) comprises an operation mode in which, for the initial heating-up of the paver screed (10), the voltage (U), the electrical heating elements (2) are charged with, is adjusted such that the current generator (1) is operated at overload, in particular at maximum overload, and upon exceeding of a particular temperature (Ts) measured at the current generator (1), in particular of a particular winding temperature of the current generator (1), and/or upon exceeding of a particular temperature (Ta-Tx) measured at the paver screed (10), in particular of a particular temperature (Ta-Tx) of working components of the paver screed (10), the voltage (U), the electrical heating elements (2) are charged with, is reduced to a voltage (U) at which the current generator (1) is operated at nominal load or partial load.

47. Road paver according to claim 41, characterized in that the control unit (3, 4) is designed in such a way that it can increase the voltage (U), the electrical heating elements (2) are charged with, starting from a voltage (U) at which the current generator (1) is operated at nominal load or partial load, in dependency of one or several operating parameters (Ta-Tx, Ts) of the road paver, of the paver screed (10) and/or of the current generator (1) to a voltage (U) at which the current generator (1) is operated at overload.
